(19) United States
(12) Patent Application Publication
(10) Pub. No.: US 2017/0255185 A1
(43) Pub. Date: Sep. 7, 2017

(54) SYSTEM AND METHOD FOR GENERATING CUSTOM SHOE INSOLE

(71) Applicant: Glen D. Hinshaw, Carlsbad, CA (US)

(72) Inventor: Glen D. Hinshaw, Carlsbad, CA (US)

(21) Appl. No.: 15/444,139

(22) Filed: Feb. 27, 2017

Related U.S. Application Data
(60) Provisional application No. 62/301,920, filed on Mar. 1, 2016.

(51) Int. Cl. G05B 19/4099; G06N 5/02; G06F 17/50; A43B 13/00

(52) U.S. Cl. CPC G05B 19/4099; A43B 13/00; G06N 5/022; G06F 17/5009; G05B 2219/49023

(57) ABSTRACT

The present invention is a system and method for measuring and generating a customized foot orthotic insole that may be inserted into footwear, to reposition the foot to that referenced neutral position or as close to that position as the individual can tolerate. The present invention can scan, manufacture, and dispense the custom insole at an integrated station that can be located in a specialist's office, but also in retail space, malls, airports, etc. The invention allows a customer to have his or her foot scanned using different types of three dimensional scanning or pressure scanning devices, whereupon the information from the scan(s) is/are fed to a semi-automatic design system, where computer programs and specialized AI algorithms create a custom insole design.

### CROSS-REFERENCE TO RELATED APPLICATION

This application claims the benefit of priority to provisional application 62/301,920, filed on Mar. 1, 2016, the content of which is incorporated herein by reference.

### BACKGROUND

This invention generally relates to foot orthotics insoles. More specifically, this invention relates to a method and system for designing and manufacturing custom shoe, midsoles, insoles, sandals, flats, and other shoewear by capturing the dynamic and static foot contours and sizes in a weighted and unweighted state, and rapidly generating foot orthotics using additive manufacturing (e.g., 3D printing) at the point of scan, with onsite evaluation, design and manufacture.

Patients who suffer foot ailments often seek shoe inserts, or “insoles,” to relieve minor pains and discomforts attributable to injuries, fatigue, physiological issues, and the like. Podiatrists often prescribe simple inserts to relieve symptoms of plantar fasciitis and improve pronation/supination control. The prior art offers a variety of devices that can be inserted into a patient's shoe, to support and relieve the foot. These inserts run the gamut from rubber or silicone heel cups to full-length viscoelastic or cork inserts. Some have medial arch build-ups, while others are completely flat. There are also some inserts containing magnets, rubber elements, and gel-filled sacs.

Most off-the-shelf shoe inserts are selected based on the patient's shoe size. From the manufacturer's standpoint, this model makes sense from a stocking and pricing advantage where a limited number of sizes are available that conforms to a generally high “average” foot shape and contour. From the patient's perspective, off-the-shelf inserts offer greater availability, no waiting period, and low cost of initial purchase and replacement insoles. One difficulty is that no one has an “average” shaped foot, and patients whose feet are not average or standard can encounter problems with a one shape fits all option. Specifically, because these products are designed for people with differing foot conditions but the same shoe size, specific corrections can't be expected. Even with products that can be somewhat customized, the potential for individual modification is quite limited. When patients need correction of symptomatic conditions and/or biomechanical imbalances, they may require certain heel wedges or a properly placed support for the metatarsal arch that can't be obtained from generic shoe inserts.

Because of these shortcomings, doctors have begun prescribing custom made insoles more and more to address specific problems that their patients have developed with their feet. Custom-made orthotics are individualized shoe inserts, made from an image of the patient's foot, sometimes with specific added corrections. The process typically involves products made from a plaster cast, mold, or weighted or unweighted foot scan using a scanning device. In accordance with this process, a physician oversees the capture of a patient's foot characteristics after manipulating the foot to a referenced neutral position subject to compensation for any observed anatomical deformities of that foot. A non-weight bearing condition exists when no forces are applied to the foot, such as when the foot is suspended in air, and a weight-bearing condition occurs when the patient is standing and casting, molding or scanning the foot while supporting the patient's weight. The insole can be based on either a weight-bearing, semi-weight-bearing, or even non-weight-bearing “subtalar-neutral” foot image.

The physician then sends the foot characteristics and measurements to a laboratory to make a foot orthotic with CNC, 3D printing, or mold from the patient's cast. The laboratory technician uses the patient information, a priori knowledge of the practitioner's procedures, and other experience to modify the patient's molds or corresponding orthotic block that is finished at the laboratory, and sends a custom insole back to the physician. The physician then calls the patient to return to the physician's office to pick up the insole. If a patient reports only minor or no relief or reports discomfort, the practitioner must reevaluate the patient. If changes to the orthotic footbed are required, then either the entire process must be repeated or the orthotic footbed must be sent back to the laboratory with instructions for additional corrections.

The main advantages of custom-made orthotics are the excellent, personalized fit and the individualized correction of biomechanical faults. These factors help ensure rapid adaptation and relief of underlying and associated musculoskeletal problems. For example, when dealing with poor support for the pelvis and spine, a custom fit provides a more predictable response and longer-term symptom relief. Activity levels and body mass can also be taken into account when ordering custom orthotics. Specific corrections, asymmetrical posting and lifting, and support for unusual and anomalous anatomy can also be requested. This becomes important when it is recognized that abnormality and asymmetry are common. A heel spur correction built into a custom orthotic will often provide immediate relief.

The process described above for obtaining a custom insole is time-consuming and depletes resources, making custom orthotic more expensive than an off-the-shelf orthotic. The effectiveness of the insole also depends highly on good quality control at both ends of the production chain. One of the most significant drawbacks for the patient is the long time lag between the fitting to the request for customization to the delivery of the custom insoles.

The present invention seeks to overcome many of the shortcomings from the patient's perspective in the process of obtaining customized orthotic insoles.

### SUMMARY OF THE INVENTION

The present invention is a system and method for measuring and generating a customized foot orthotic insole that may be inserted into footwear, such as a shoe, cleat, ski, boot, or the like, as well as midsoles, flats, sandals, and other shoewear, to reposition the foot to that referenced neutral position or as close to that position as the individual can tolerate. The present invention can scan, manufacture, and dispense the custom insole at an integrated station that can be located in a specialist's office, but also in retail space, malls, airports, etc. The invention allows a customer to have his or her foot scanned using different types (optical, pressure, thermal, etc.) of three dimensional scanning or pressure scanning devices, whereupon the information from the scan(s) is/are fed to an automatic or semi-automatic design system, where computer programs and specialized AI algorithms create a custom insole design. The design is communicated to a local manufacturing system capable of additive manufacturing for the main body of the insole and specialized equipment for the top cover bonding and cutting operation. The manufacturing system creates a custom insole from the just scanned information, along with any special instructions from the customer. The customer can then pick-up the custom insole and bring it home minutes after the scan was taken.

These and other important advantages of the present invention will be apparent in view of the detailed description of the invention below, along with the accompanying drawings described herein.

### BRIEF DESCRIPTION OF THE DRAWINGS

FIG. 1 is an elevated, perspective view of an all-in-one station for creating a custom orthotic insole for a patient;

FIGS. 2 and 3 are elevated, enlarged perspective views of scanners;

FIG. 4 is an exemplary questionnaire for use in diagnosing the customer's condition;

FIG. 5 is an exemplary activity survey that may aid is the design process;

FIG. 6 is a scan graphic showing the scan results and insole design with questionnaire and survey input;

FIG. 7 is an elevated perspective view of a 3D printer cage;

FIG. 7A is an enlarged perspective view of trays used to print the insoles on;

FIG. 8 is an enlarged perspective view of the 3d printer head assembly;

FIG. 9A is a schematic diagram of the printer board switch function for detecting z-axis;

FIG. 9B is a schematic diagram of the printer board switch function in the closed position;

FIGS. 10A and 10B are schematic diagrams of the printed insole and cover in front and side views;

FIG. 11 is an enlarged photograph of a portion of a printed insole using the kiosk of FIG. 1; and

FIG. 12 is a flow chart of the process for creating the orthotic insole using the kiosk of FIG. 1.

### DETAILED DESCRIPTION OF THE PREFERRED EMBODIMENTS

Industries use mass production to manufacture their products, which results in thousands of products having identical physical characteristics since one mold is used over and over again to generate said thousands of products. The present invention uses three dimensional printing in combination with on-site data taking equipment to customize products to customers' personalized needs. Three dimensional printing allows for any customization to be possible without undue expense, since the printing operation can be modified to accomplish the customization easily and efficiently.

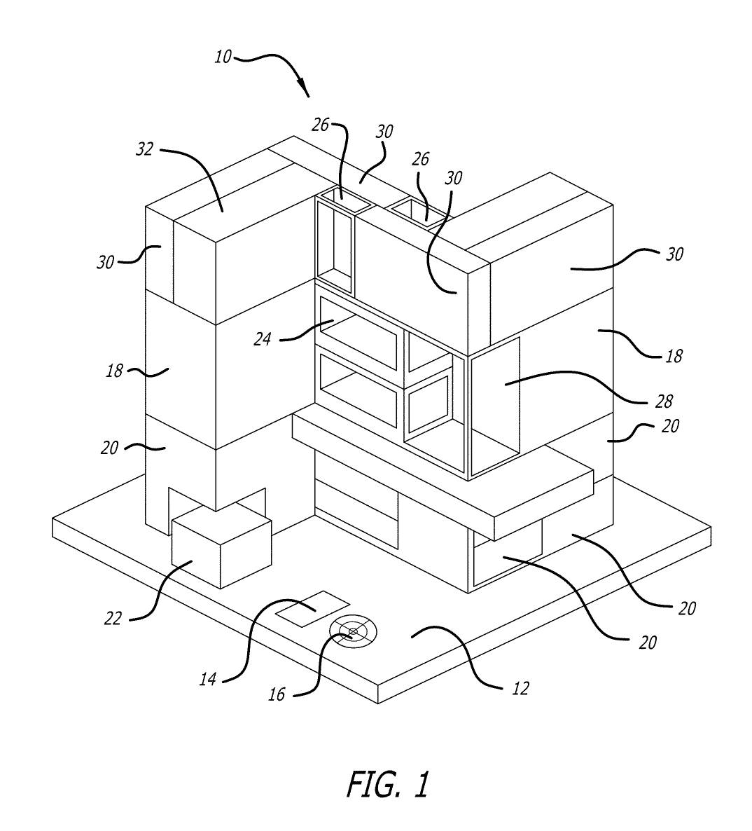

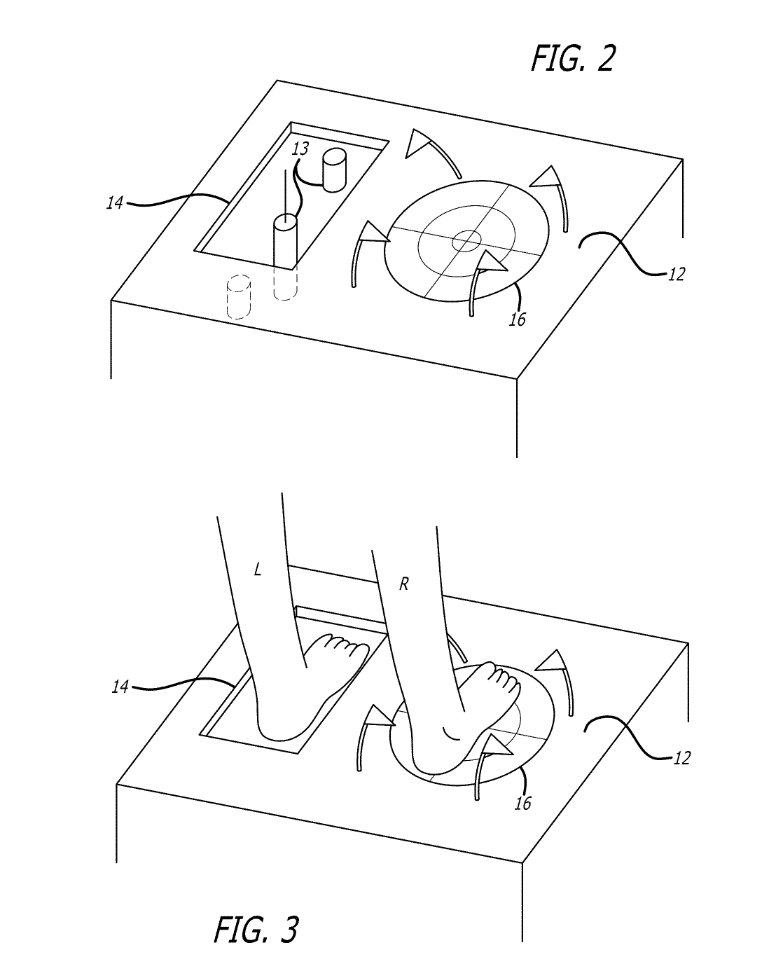

FIG. 1 illustrates a kiosk 10 corresponding to a first exemplary embodiment of a system and method for carrying out the present invention, whereby a customer or patient can have his or her foot physiology scanned for processing in order to make a custom insole or other footwear product. Although this application uses the term “insole” hereafter, it is to be understood that the invention applies to a broader array of foot care and foot wear products than mere insoles, and those products include midsoles, flats, sandals, inserts, orthotics, and other similar items that benefit from customization of the patient's foot. In a first preferred embodiment, the kiosk 10 in FIG. 1 is formed of elements having heavy paper or cardboard shells/housings that are connected or combined to form a kiosk monument such as that shown (although alternate configurations are possible and within the scope of the invention). The kiosk 10 is mounted to a heavy duty floor/stage 12 into which two specialized foot scanners are incorporated. The first scanner 14 may be an optical scanner that uses cameras 13 to obtain three dimensional image data about the patient's foot contours and size, and the second scanner 16 may be a pressure or gel scanner that uses pressure sensors (not shown) or other pressure techniques to obtain static and/or dynamic pressure measurements to evaluate topographical features of the patient's foot (FIG. 2). The patient can stand on each scanner (FIG. 3) to have his/her foot optically scanned and pressure-scanned using the two scanners 14,16, which send data to a central data repository located in one of the computers residing in the kiosk, where said data can be ultimately synchronized and uploaded to the internet via a network connection. In a preferred embodiment, two additional scanners are located on the opposite side of the kiosk 10 in a symmetric configuration so that the kiosk 10 can operate as a double customer station simultaneously.

The kiosk may include several storage modules 20, including one that includes a removable seat/cushion 22 so that the customer can use the seat while performing the measurements for the unweighted testing. The kiosk 10 is also provided with several three dimensional printers 24 each associated with a filament feed supply module 26, such that insoles may be manufactured on site directly using the three dimensional printers 24 based on information received from the scanners 14,16. The three dimensional printer 24 and filament feed supply module 26, along with the cutting and gluing station, comprise the manufacturing stage of the operation where the product is fabricated. The three dimensional printer 24 includes equipment for cover gluing and cutting to complete the insole manufacturing process post-printing. The kiosk 10 may preferably be formed with a product sample display module 28 where samples of the products may be observed and consumer information can be offered. The kiosk 10 may also be provided with a plurality of television monitors 30 for playing prerecorded infomercials about the products, and the monitors may also provide the customer with specific information about the current process and status of each stage of the insole manufacturing procedure.

The kiosk is assembled by folding and bending the cardboard shells to create the three dimensional kiosk multi-customer station. Because most the kiosk is constructed using thick cardboard, its transport is easy as it can be transported flat and assembly is straightforward as the components quickly fold and merge into place. Each kiosk is configured to be portable and ships in a standard freight shipping container.

The scanners and printers may be controlled by a tablet, smart phone, or other handheld device that can relay commands to the various elements of the system. The tablet or smartphone preferably runs an application that includes a graphic user interface where tasks can be carried out such as initiating a scan of the patient's foot, recalling or storing patient information from a data storage or remote servers, conducting transactional or commercial operations such as credit card purchases, billing options, shipping instructions, and related procedures. An operator can log in to the system using a username and password, and conduct various operations in the process of generating a custom insole. The graphic user interface may also include a display for showing the image of the scanner/camera and the progress of the printing operation. That information is available on the television monitors 30 so that so that sensitive information can be kept for operation display only, while other information, such as full insole 3D design and foot scan, can be made available for the patient.

A first preferred embodiment uses various special purpose three dimensional scanners to generate a three dimensional scan of the customer's foot, which may also include both a static and dynamic pressure profile. An alternate embodiment uses a thermal film capture technique to develop a profile of the customer's foot. Control panel input allows certain information to be entered into the system, such as the personal information of the customer, whether the scan is for a left or right foot, for a male or a female, the age of the customer, etc. The control panel may ask the customer to release the operator for use of the scanned images obtained on every scan, or confer ownership of the images to the operator for research and further product improvement. Information entered at this stage of the process is used later along with statistical and other general purpose data by a special artificial intelligence (“AI”) design system to create the necessary instructions and specialized treatment of the three dimensional geometries to achieve the final product.

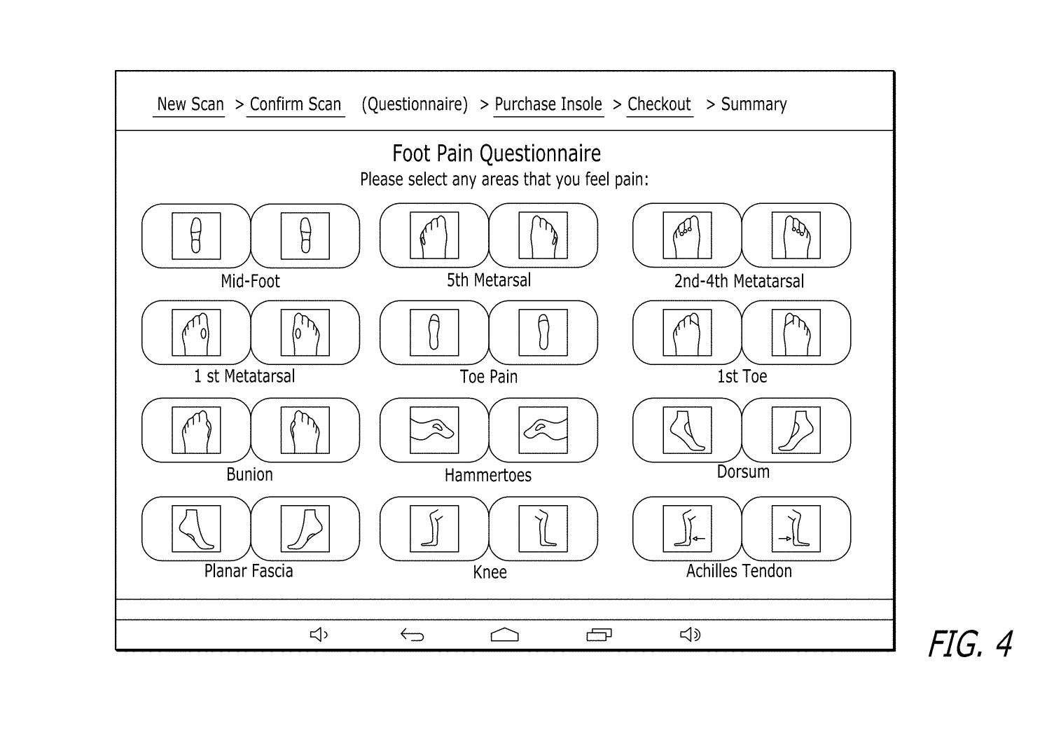

FIG. 4 depicts a questionnaire that the customer can take to better aid the operator in customizing the insole. Data gathered from this questionnaire helps to guide the program as to where the customer is seeking relief and what current issues the customer may have. Information may also assist the semi-automatic AI design system and/or operator to elect corrections or modifications on the insole model. Further, the answers may suggest parts or adjustments depending customer needs and foot type. In a preferred embodiment, the data is incorporated into an intelligent learning algorithm to predict features and solutions to insoles from data gathered.

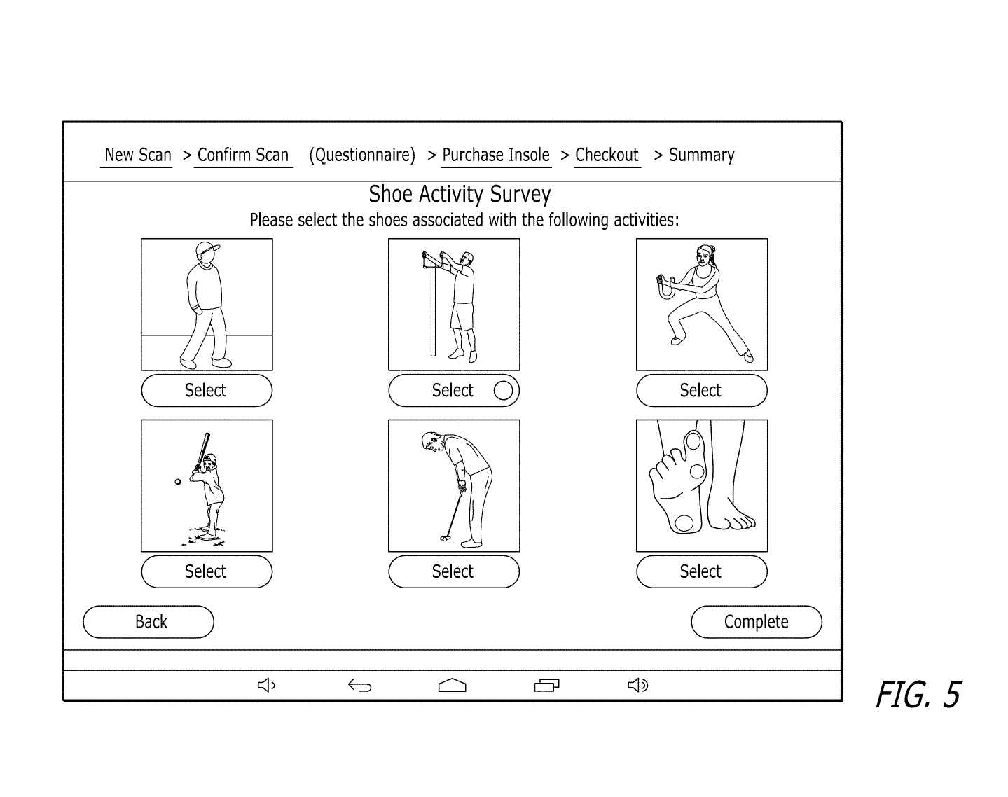

FIG. 5 depicts an activity survey that can be used to further gather information about the user and the conditions under which the insoles will be used. This information is helpful in understanding which shoe brands and brand models the customers are wearing, as well as the customer's intended sports and activities. Foot scanned data and customer provided information may be used to complete a comprehensive evaluation of the customer and their feet. When insoles are designed off site, this helps the CAD automatic design system to see and understand the customer's foot evaluation. All of this foot data is used to determine which insole type, size and treatment is best suited for the customer's needs.

After the foot evaluation and scan process, the customer may be invited to make an informed purchase decision based on the facts and data presented. A variety of product types may be offered, including materials, adjustable modular insole fitting kits, heat moldable insoles and/or full custom orthotic milled or 3D printed insoles. If full custom insoles are elected, they can be made using traditional EVA foam and mailed to customer in one to two weeks. Alternately, custom 3D printed insoles can be generated on site and ready for the customer while they wait. 3D printed insoles are typically made in-store unless the customer is special ordering or orders multiple units requiring off-site manufacturing.

Customers may also choose more customized, activity specific designs & techniques including: material inlays 3D printed together with flexible materials (carbon, nylon, Kevlar); 6-axis force sensor/pressure sensor placement in printed insoles that allow force and shear pressure measurement; embedded sensors for smart phone integration and activity tracking wireless communication protocols, which would allow data mining of compression models, gait cycle & stress determinations, and; conductive printed structural design algorithms to allow for matching shapes and force from dynamic weighted foot scanner. The pressure profile from the kiosk can also be used to help calibrate wearable conductive insole systems printed on the kiosk that allow for wireless feedback from the three dimensional printed conductive insole/midsole.

Once the scan is initiated, the three dimensional files and pressure files are generated by specialized computer programs running on the main computing system within the workstation 18. The display can then be selected to actuate a viewer such as, for example, the WebGL 3D viewer, powered by libraries such as Three.js libraries. This viewer displays one or more color images of pressure/3D data applied by the user's foot and is intended to show the customer where the highest incidences of pressure occurs for various conditions of the user's foot. For example, length of the arch, maximum pressure on the heel, and general areas of high and low pressure can readily be seen from the data, and trained medical technicians will discern further information such as the specific arch type, as well as some observations about the customer's feet (including but not limited to: pronation, supination & weight distribution). Other features may include automatic foot detection, depth colorization, detect miscalibrated scan activity, 3D dynamic view control (including lighting, pan, tilt, zoom), 3D visual representation of foot force, automatic file smoothing & processing, heel, forefoot, metatarsal, foot-length and arch height detection and measurement, measurement of weight and pressure by using gel displacement algorithm, automatic product and treatment recommendations, automatic generation of insole baseline model ready for customization, and sharing foot shapes via Email & other online social media avenues with secure URL. The scanners 14,16 are also able to gather entire foot information (and not merely from the plantar surface) that can later be used for data analysis in connection with foot conditions and footwear fitting.

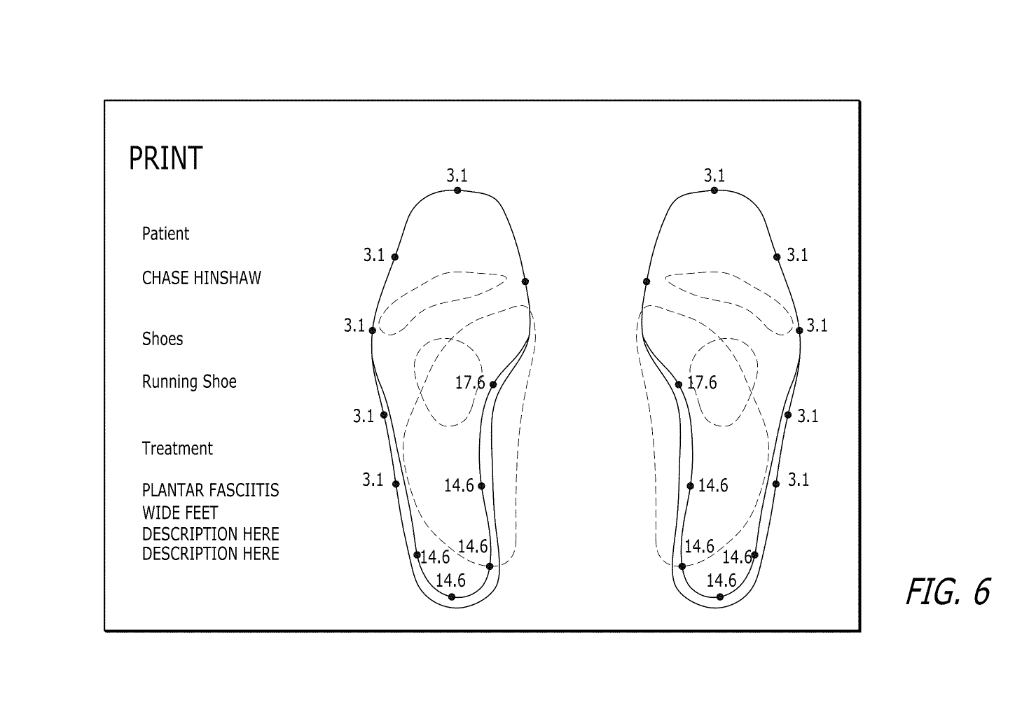

Once the order is placed, the process shifts to the semi-automatic AI CAD insole design system to complete the design file. The insole design process consists of at least two design stages, namely feature selection and feature application/combination with 3D/pressure data. In the first stage, a semi-automatic AI-based system generates a feature map such as that depicted in FIG. 6 illustrating an insole profile where specific 3D scanning data characteristics are converted into a customer-specific product. The map includes topographical information and material data for creating the specifically designed product based on the scan data and customer supplied data, in part to balance gait pattern and/or change pressure redistribution. In the second stage, the feature map is combined with measured/pressure data, shoe template contour and product type and material characteristics to provide a final 3D CAD model of the insole. Some of the inputs may include:

model type, material, top-cover & extra features input from the order section;

brand sole shapes based on shoe size and scan data (outline cuts & shapes);

any further insole modifications based on data from foot & shoe surveys;

speed and density based on basic size of insole;

confirm or edit insole brand-type and size based on foot & shoe data; and

add/modify insole shape corrections for arch, heel, forefoot & toe area and add/edit modifications to help correct foot orientation and health conditions.

After the insole design has been completed, either automatically or with the aid of an operator, the CAD design is exported for 3D printing. This process, known as “slicing,” converts insole modifications and settings into a final printable set of low level machine instructions, such as G-Code. The three dimensional printing provides for the following advantages and capabilities:

Targeted support based on features defined by foot, shoe & pain surveys along with order and added-feature details.

Automatically insert customer name & order number, or other textual or design features, on bottom or sides of the insoles

Multiple proprietary materials & densities

Added density/strength for greater support

Reduced density to offset certain areas (forefoot drop)

Density structures build around shoe, activity and customer's gait cycle

Biometric internal high-density support mesh

Product duration can be extended with higher priced materials and longer print times

Use of filament color changes to delineate feature changes & transitions, and

External wire mesh exoskeleton combined with infill filament structure provides for a design technique that is well adapted for use with high-speed, high support-strength materials.

The slicing process is tailored to the specifics of the materials to be used and 3D features, and is integrated within the application. Either standard or custom developed slicing routines are used for this purpose. The slicing also adds some target marks to assist in the alignment process between printing and cover cutting.

After the low level machine instructions are generated, a specialized label printer issues a sticker 60 with a QR or similar optical recognition code. This sticker 60 is placed in a printing tray 62 for one insole or a pair, containing a reference code to the specific 3D design and sliced low instructions machine codes. Every printing unit has an optical recognition system that recognizes the QR code on the tray 62 and retrieves the appropriate file/files to be printed from a centralized repository within the workstation. If the file is not found locally within the kiosk 10, an online search for the specific file is performed in the cloud allowing printing of the patient's insoles in the kiosk where the file was generated or in any other kiosk station.

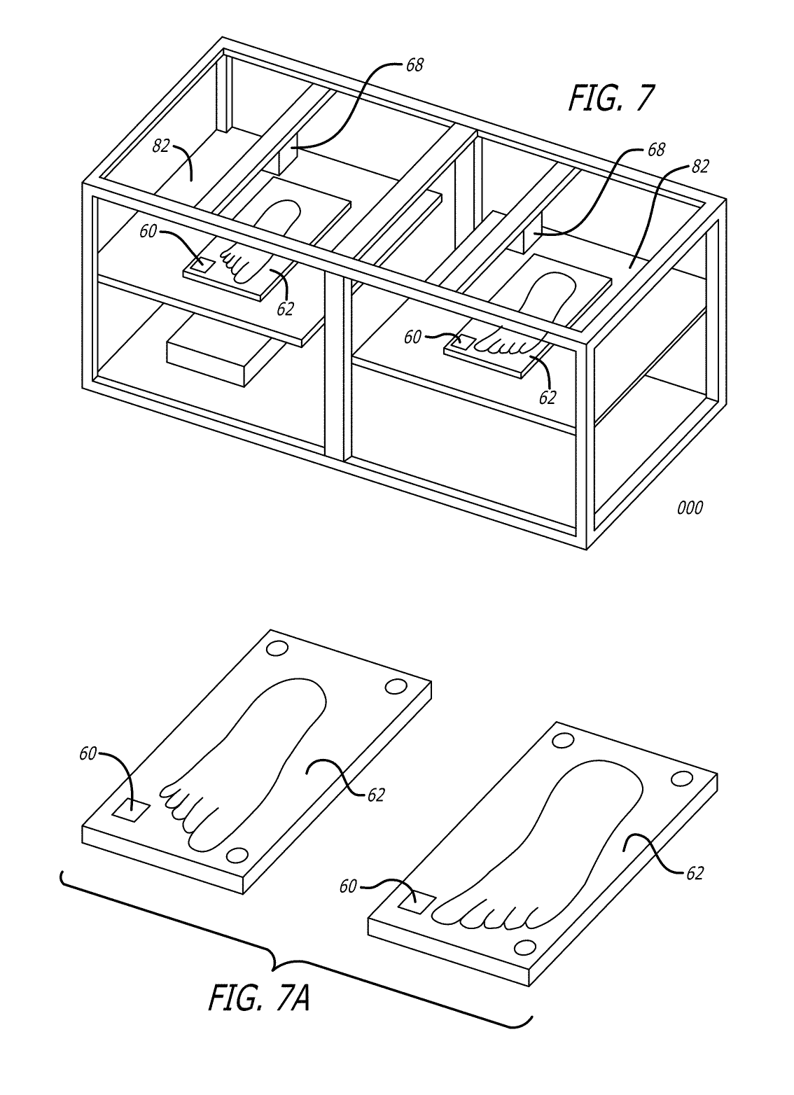

To print a file, the operator only has to get the tray 62 into the printing unit 64 (FIG. 7) and initiate the print job. Information about the current printing status and issued QR codes are monitored using either the overhead displays 30 or any system capable to interface with the kiosk, such as a smartphone, tablet, or the like. Customers are able to receive notifications on the printing process, allowing them to perform other activities within the environment where the kiosk is located, or returning back to it as soon as an alert is received signifying the printing process is complete. The alert could come in the form of an email, SMS notification, instant message, or other specialized communication for this purpose. The printing progress is also displayed on the monitor 30 so that the customer can view the progress in real time, and in a preferred embodiment the progress can be viewed by accessing a digital feed of a camera documenting the progress using an internet feed or the like.

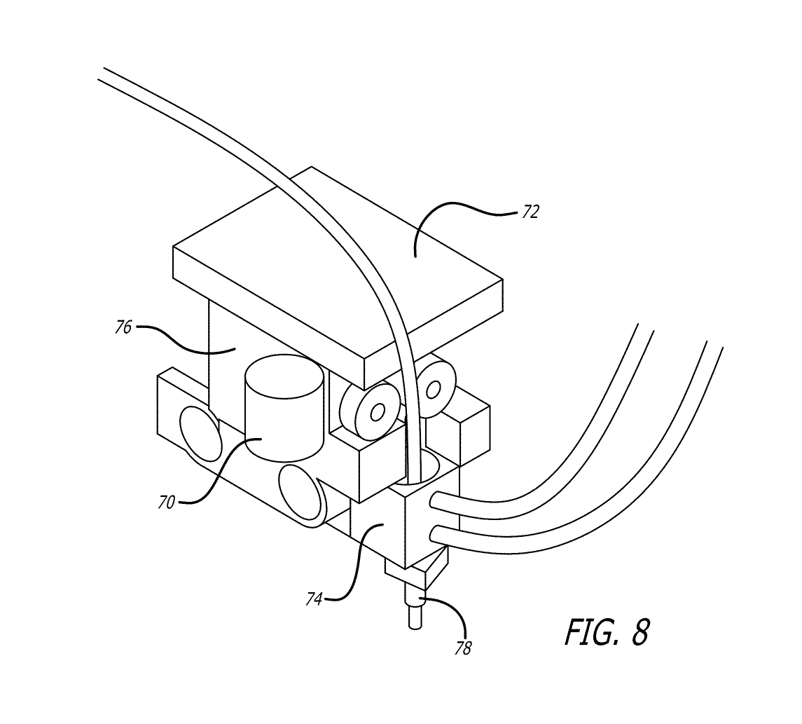

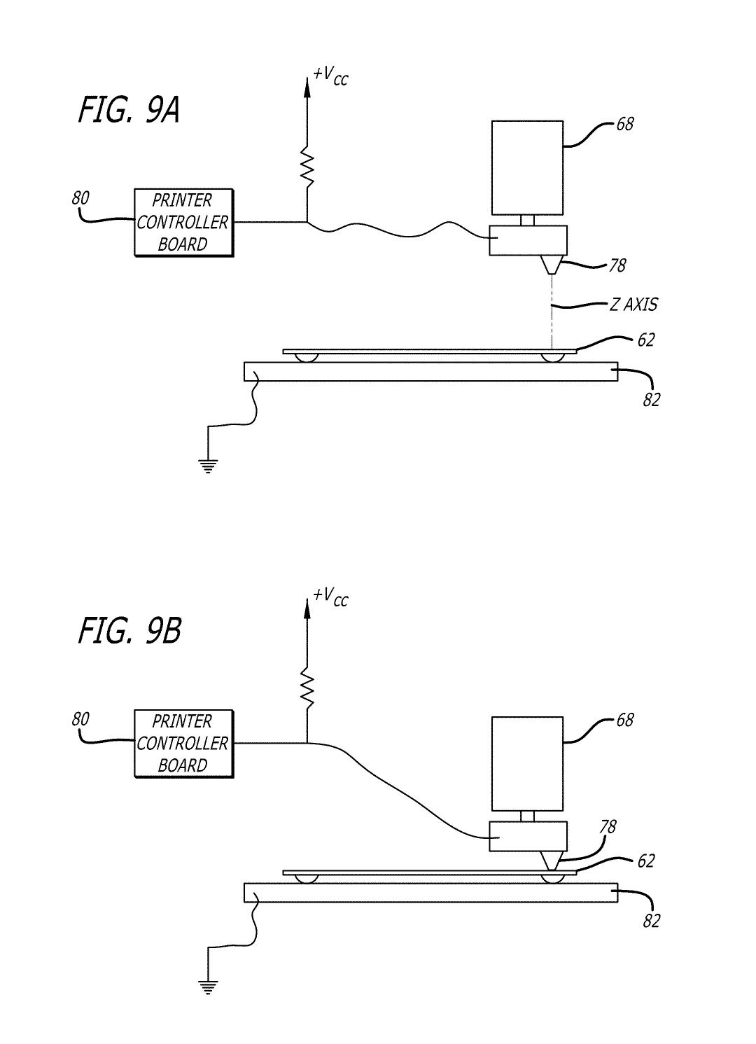

The printing units 64 include several independent heads 68 that are able to move in the X, Y, and Z directions, which allow the printer to be able to print two insoles simultaneously. A specialized computing system streams low level machine instruction codes to the multi-head printing unit 64, keeping sync of the work to be performed. Every head 68 (FIG. 8) has its own camera 70 for optical recognition of QR codes and a controller board 72 for operating the printer movement. A water cooling system 74 ensures proper filament temperature and a drive motor 76 provides the motive force for the printer head across the rails of the printing unit 64. A probe system 78 is mounted below the print head to recognize bed levelling and compensate for bed irregularities. As shown in FIGS. 9A and 9B, the probe 78 of the printer head 68 is connected to a controller board 80 and is coupled to a voltage source. When the probe makes contact with the bed as shown in FIG. 9B, the control board detects the closure of the circuit as the voltage source is connected to the bed 82 and the thus the level of the bed is set and the z axis is established.

Every printing head preferably contains a serial number with all of its calibration and configuration parameters, such as camera offset to printing offset (used for cutting part alignment), bed levelling sensor calibration, temperature and/or nozzle diameter compensation, etc. When the computing system within the printing head is turned on, it retrieves its configuration parameters either from the kiosk local database or from the cloud, based on its serial number, allowing quick replacement.

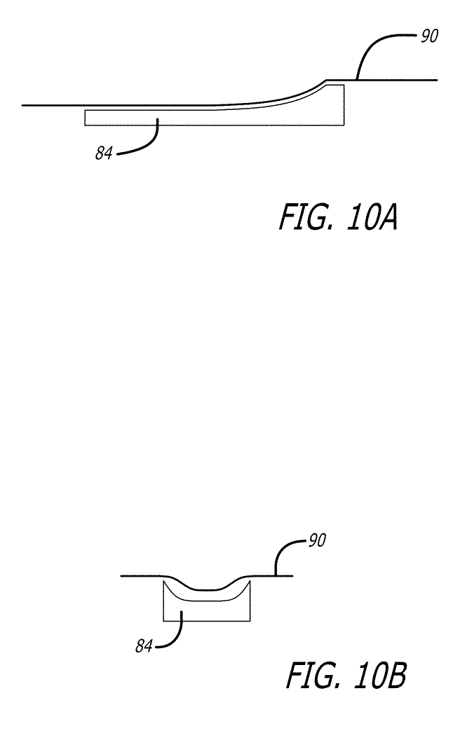

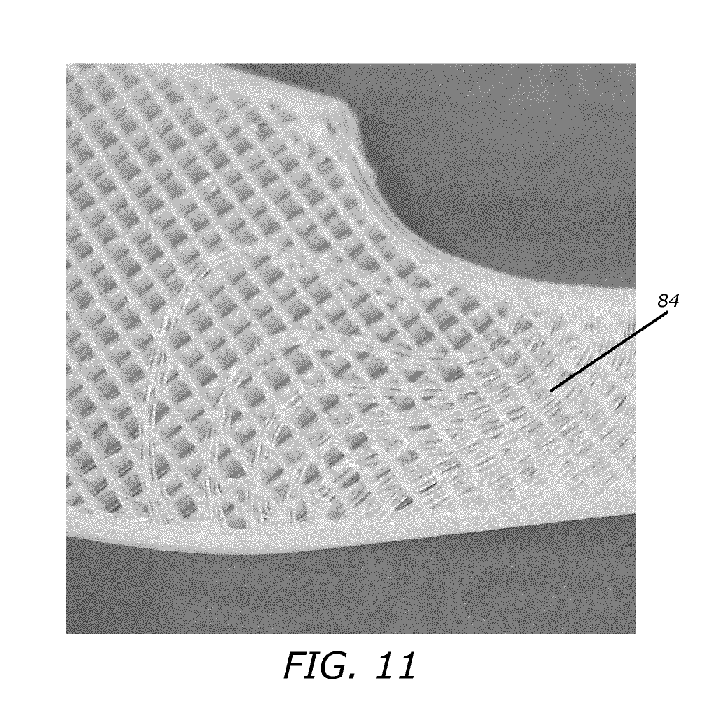

After the main 3D body 84 of the insole is printed FIG. 11), a soft cover 90 is placed on top of the insole (FIGS. 10A,10B). The specific cover to be placed is chosen in the pre-print process. The cover 90 goes into a specialized gluing station within the kiosk where the appropriate glue is applied on top of the 3D printed insole. This gluing station can be manually operated or by specialized robotic arms/systems to provide correct bonding between the insole body and the top cover.

After the cover has been glued, its contour has to be cut as exact as possible to the outer insole contour. Because of the need for high accuracy in the top cover trimming process, manual cutting is not always proper and the insole finishing quality is heavily affected by operator skills. To alleviate this problem, a specialized knife/laser cutting unit(s) 99 is provided in or adjacent the printer unit. In a preferred embodiment, a laser unit 99 is mounted on the printer head 68 and is guided by the same processor as the printer head and driven by motor 76. That is, the laser moves around the contour of the insole to cut the insole and the cover in a precise manner guided by the same set of instructions used to print the insoles. Alternatively, the laser can be mounted separate from the printer head 68 as a stand-alone component driven by an independent motor 101 (FIG. 10A,B). In the latter case, the cutting stations are similar to the printing stations, but the laser mechanism or other cutting instrument replaces the printer head, and trims the excess material of the cover and insole to complete the manufacturing process.

In order to correctly cut the perimeter of the insole, the cutting system has to perform the following steps:

a.) Identify the model to be cut

b.) Align the 3D printed part to its own reference system using tray alignment holes 69, which are mounted on pegs (not shown) on the bed 82;

c.) Perform the actual trimming process either using laser or a specialized blade, optionally using high temperature.

In step a), the QR code in the tray is used. Therefore, the printing head for the cutting system also contains a camera with optical image recognition hardware. In step b), specialized marks are printed on the insole platform as part of the 3D printing process, so that the reference systems of the printing unit and cutting unit can be aligned. In step c), a CNC control system is guided by the contour generated by the specialized slicer/contour generator system.

As part of the customization process, a customer may select covers or parts from pre-defined material options. A sales representative, a lab technician, or a customer can select adhesive or hook back adjustable parts for further contouring or shape modifications. Printed parts can be bonded or applied to pre-made insole shells. Re-forming or remaking insoles can be completed in view of customer feedback. The final files are saved and upload to online customer profile, and the customer has the option to purchase the 3D shape file of the insole or foot shapes file for future use.

The customer may provide feedback after wearing the insole or orthotic using specialized applications and/or web based systems. This feedback is incorporated into future designs for the particular patient, as well as used in the AI programming to modify the design for future products so that it can better anticipate customer needs and perform better.

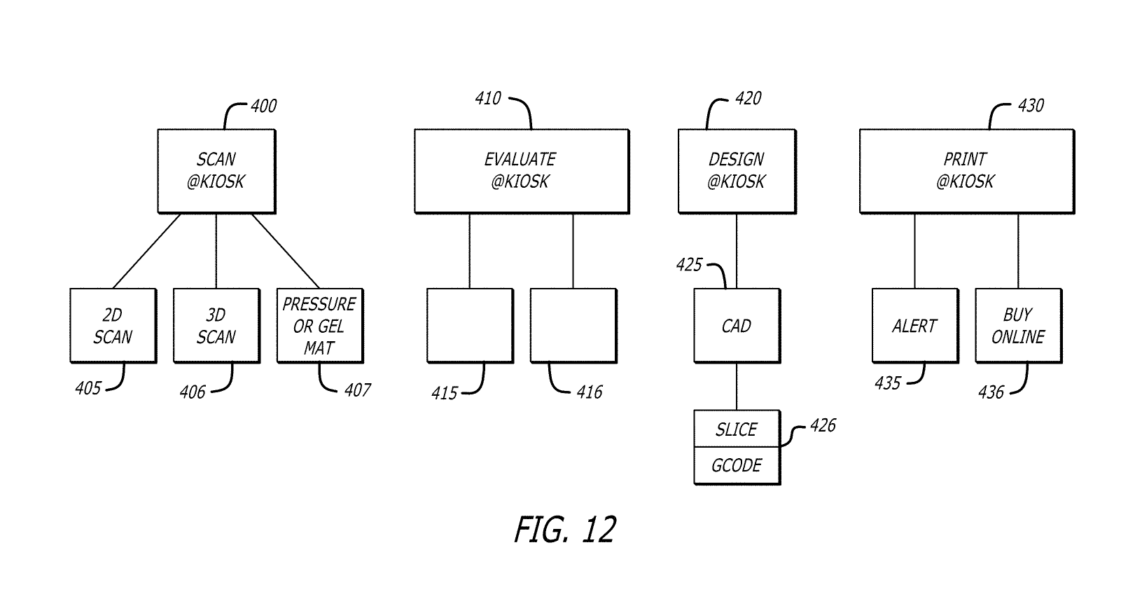

FIG. 12 is a flow chart illustrating the method of scanning, designing, printing, and ordering the insole of the present invention. In step 400, the kiosk 10 is unpackaged and assembled in a customer populated area such as a mall, department store, airport, shoe store, or other location where customers would be served by the present invention. In steps 405, 406, and 407, respectively, the customer steps onto the kiosk's platform where the scanners and located and a 2D, 3D, and/or pressure scan of the customer's feet are performed. The results of the scans are digitized and saved to a file that can be analyzed by software developed for the present invention.

The customer then proceeds to the evaluation area of the kiosk in step 410, where the customer can take a questionnaire and/or activity survey in step 415, and identify preferences or medical conditions in step 416 that will aid in the design of the insole. The customer proffered data in step 410 plus the scanned results from step 400 are combined into a design program in step 420, which takes CAD design in step 425 and converts those designs to printer code language such as slice or GCODE in step 426 that can be communicated to the printer station for immediate printing of the insoles. The instructions are also assigned to a unique QR or other optical code that can be imprinted on a sticker, which is then placed on a tray that can be read by the printer head's camera. The printer then retrieves the instructions for the insole based on the QR code or other optical code, where the instructions may be stored locally or remotely (or in the Cloud).

The printer retrieves the instructions and begins to print the insole in step 430, while displaying the progress of the print operation to either the monitors 30 on the kiosk or to an online feed that can be retrieved by a smart phone or other handheld device or internet based device. In step 435, an alert is sent to the customer either by email, SMS text message, iMessage, or other electronic message when the print process is complete so that the customer, who may be shopping during the print operation, can come pick up the insoles. The customer is also given the opportunity to order additional insoles with the custom shape and design online in step 436 using a special code provided by the order information or the QR code provided with the receipt (or other identifier).

The foregoing descriptions and illustrations below are intended to be illustrative and exemplary but not limiting. One of ordinary skill in the art would readily recognize and appreciate many modifications and substitutions to the foregoing examples, and the present invention is intended to include all such modifications and substitutions. Thus, for purposes of construing the breadth of the invention, nothing herein should be deemed as limiting unless specifically characterized as such.

We claim:

1. A method for fabricating a custom shoe insole, comprising:
providing a mobile kiosk;
scanning a customer's feet at the mobile kiosk;
communicating scanning data to a three dimensional printer at the kiosk;
printing a custom shoe insole using the three dimensional printer from the scanning data; and
covering the printed custom insole with a flexible cover.
cutting the covered, printed custom insole at the kiosk.

2. The method for fabricating a custom shoe insole of claim 1, wherein the scanning step comprises an optical scanner.

3. The method for fabricating a custom shoe insole of claim 2, wherein the scanning step further comprises a pressure scanning.

4. The method for fabricating a custom shoe insole of claim 3, wherein the pressure scanning is a static measurement.

5. The method for fabricating a custom shoe insole of claim 4, wherein the pressure scanning also includes a dynamic measurement.

6. The method for fabricating a custom shoe insole of claim 1, further comprising a step of displaying on a monitor a progress of the printed step.

7. The method for fabricating a custom shoe insole of claim 1, wherein the three dimensional printer is connected to a remote data storage providing supplemental information on insole manufacturing methodologies, and wherein the three dimensional printer accesses the remote data storage to obtain the supplemental information prior to initiating the printing step.

8. The method for fabricating a custom shoe insole of claim 7, where the remote data storage is the Cloud.

9. The method for fabricating a custom shoe insole of claim 7, where the supplemental information includes three dimensional printing instructions.

10. The method for fabricating a custom shoe insole of claim 7, where the supplemental information includes customer information.

11. The method for fabricating a custom shoe insole of claim 1, wherein the scanning step uses a thermal film to profile the customer's feet.

12. The method for fabricating a custom shoe insole of claim 1, further comprising a step of entering instructions via a graphic user interface prior to customizing a printing operation.

13. The method for fabricating a custom shoe insole of claim 1, further comprising a step of using artificial intelligence to design the insole.

14. The method for fabricating a custom shoe insole of claim 1, further comprising using a conductive material to fabricate the insole, and acquiring wireless feedback from the conductive insole to improve subsequent printing operations.

15. The method for fabricating a custom shoe insole of claim 1, further comprising providing a questionnaire to the customer prior to initiating the printing step, and using answers from the questionnaire to influence a selection of the custom insole.

16. The method for fabricating a custom shoe insole of claim 1, further comprising embedding a sensor into the insole for activity tracking.

17. The method for fabricating a custom shoe insole of claim 1, wherein a design process includes a first stage where a feature map is generated to determine modifications to a baseline model, and a second stage where the feature map is combined with scanned data and material characteristics to provide a final design model of the insole.

18. The method for fabricating a custom shoe insole of claim 1, further comprising generating a unique optical recognition code for each pair of insoles designed, and assigning the unique optical recognition code of the insoles to the printer to retrieve a print file associated with the designated insoles.

19. The method for fabricating a custom shoe insole of claim 1, further comprising automatically issuing an alert to a customer when a fabrication process is completed.

20. The method for fabricating a custom shoe insole of claim 1, wherein the cutting step is performed using a guided laser.

21. The method for fabricating a custom shoe insole of claim 20, wherein the guided laser is incorporated into a printer head used in the printing step.

22. The method for fabricating a custom shoe insole of claim 1, wherein the scanning step and printing step are controlled by a hand held device.

23. The method for fabricating a custom shoe insole of claim 1, wherein the printing step is used to create a filament structure that is combined with a wire mesh exoskeleton.

24. A mobile kiosk for producing a custom shoe insole, comprising:
a floor;
a scanner mounted in said floor;
a kiosk monument;
a three dimensional printer within the kiosk monument;
a network interconnecting the scanner, the three dimensional printer, and a remote data storage, the network including at least one local data storage; and
a network connectivity allowing the network to access the remote data storage and the internet;
whereby data from the scanner is combined with data retrieved from the local data storage to design a custom shoe insole, whereupon instructions are received by the three dimensional printer for carrying out a printing operation to fabricate the custom shoe insole.

25. The mobile kiosk of claim 24, further comprising a cover and cutting station where a printed insole is covered with a top cover and then cut using a laser or bladed instrument controlled by a computer with automatic alignment.

26. The mobile kiosk of claim 24, further comprising a monitor for displaying a progress of the printing operation.

27. The mobile kiosk of claim 24, wherein the scanner comprises an optical scanner.

28. The mobile kiosk of claim 24, wherein said kiosk monument includes a sample display case.

29. The mobile kiosk of claim 25, further comprising a printer filament feed compartment adjacent the three dimensional printer.
